(19) United States
(12) Patent Application Publication
(10) Pub. No.: US 2014/0224387 A1
(43) Pub. Date: Aug. 14, 2014

(54) METHOD OF ANNEALING COPPER WIRE FOR INTERCONNECTOR

(71) Applicant: Neturen Co., LTD., Tokyo (JP)

(72) Inventors: Yoshiki Seto, Tokyo (JP); Kunihiro Kobayashi, Tokyo (JP); Nobumoto Ishiki, Tokyo (JP); Hisaaki Watanabe, Shizuoka (JP)

(73) Assignee: Neturen Co., LTD., Tokyo (JP)

(21) Appl. No.: 14/345,901

(22) PCT Filed: Sep. 28, 2012
(86) PCT No.: PCT/JP2012/075875

§ 371 Date: Mar. 19, 2014

(30) Foreign Application Priority Data
Sep. 29, 2011 (JP) 2011-215137

(51) Int. Cl. H01B 13/00

(52) U.S. Cl. CPC H01B 13/0016
USPC 148/568; 148/576

(57) ABSTRACT

A method of annealing a copper wire for an interconnector includes heating a copper wire by a direct resistance heating or by an induction heating, a heating temperature of the heating being in a range of 650° C. to 1020° C., and a heating time of the heating being in a range of 0.3 seconds to 5 seconds.

### TECHNICAL FIELD

The present invention relates to a method of annealing a copper wire to be used as an interconnector for connecting solar cells.

### BACKGROUND ART

As shown in FIG. 4, a solar cell module 10 has silicon cells 11 and interconnectors 12 connecting the silicon cells 11. The interconnectors 12 and are formed by solder-plating a flat rectangular wire.

The interconnectors 12 are connected to the silicon cells 11 via the solder plate. However, the interconnectors 12 and the silicon cells 11 differ in thermal expansion coefficient. Therefore, due to the influence of heat at the time of soldering, bending stress may be generated in the silicon cell that has a smaller thermal expansion coefficient, and may cause warping or breakage of the silicon cell.

To address this problem, there is a need for reducing 0.2% proof stress of the interconnector. The 0.2% proof stress is an index of mechanical properties. The smaller the 0.2% proof stress of the interconnector, the more the warping of the silicon cell can be reduced.

Interconnectors are manufactured by flattening a conductor material using a die or a roller, slitting the flattened conductor material to form a thin wire having a rectangular sectional shape, heating the conductor wire, and solder plating the conductor wire.

The heat treatment after the slitting process is an annealing process, and removes the internal strain of the conductor wire that has undergone the flattening process and the slitting process, and softens the structure.

To reduce the 0.2% proof stress of a conductor wire having a flat rectangular sectional shape, an indirect heating is being proposed as a heat treatment method (see, e.g., JP2009-016593A, JP2009-027096A, JP2009-280898A and JP2010-141050A).

### SUMMARY OF INVENTION

As described above, an indirect heating type of heat treatment is being used to reduce the 0.2% proof stress of a conductor wire having a flat rectangular sectional shape. This is because the indirect heating has been considered to be advantageous as compared with a direct heating, such as a direct resistance heating and an induction heating in which the conductor generates heat itself, as the indirect heating can apply sufficient thermal energy to the conductor as compared with the direct heating (see, e.g., JP2010-141050A).

Generally, it is desirable to shorten a process time of the heat treatment for reducing the 0.2% proof stress of a conductor.

With regard to heating time, JP2010-141050A discloses the heating time of 5 to 60 seconds. To apply sufficient thermal energy to a conductor in a shorter time, the heating temperature may be increased. However, the disclosure of JP2010-141050A implies that the 0.2% proof stress reducing effect is not satisfactory when the heating time is short, and that the heating time is preferably 30 seconds or more even when the heating temperature is high.

Accordingly, it is an object of the invention to provide an annealing method which can reduce a 0.2% proof stress of a conductor with a shorter heating time.

According to an aspect of the invention, a method of annealing a copper wire for an interconnector is provided. The annealing method includes heating a copper wire by a direct resistance heating or by an induction heating. A heating temperature of the heating is in a range of 650° C. to 1020° C. and a heating time of the heating is in a range of 0.3 seconds to 5 seconds.

According to the annealing method described above, it is possible to significantly reduce the heating time. A conventional annealing apparatus requires means for holding a thermally softened copper wire during the heating process. However, according to an apparatus for implementing the annealing method described above, such holding means is not necessary due to the short heating time.

### BRIEF DESCRIPTION OF DRAWINGS

FIG. 1 is a diagram illustrating an annealing method using a direct resistance heating;

FIG. 2 is a diagram illustrating an annealing method using an induction heating;

FIG. 3 is a diagram illustrating an annealing method using a direct resistance heating; and

FIG. 4 is a diagram illustrating a solar cell module.

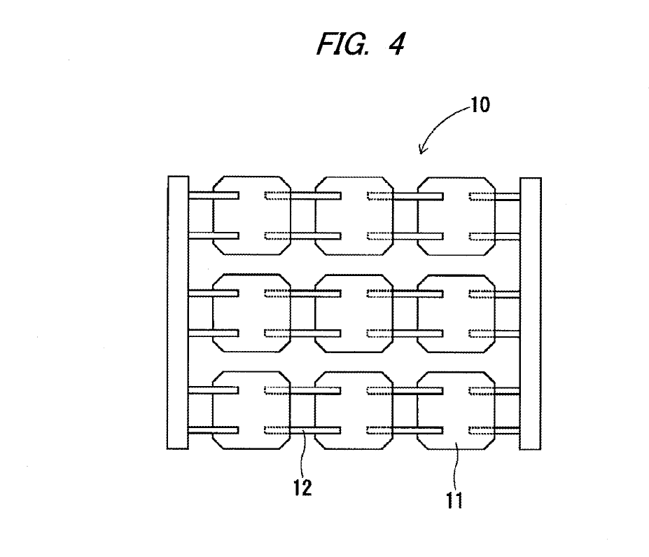

### DESCRIPTION OF EMBODIMENTS

Hereinafter, embodiments of the invention will be described in detail with reference to the drawings.

The following embodiments are directed to a method of annealing a copper wire for an interconnector, including heating a copper wire by a direct resistance heating (also called as a direct electric conduction heating) or by an induction heating, with a heating temperature in a range of 650° C. to 1020° C. and a heating time in a range of 0.3 seconds to 5 seconds.

To reduce power generation loss of a solar cell, it is desirable that a copper material have small volume resistance. Examples of the copper include a high-purity copper (a purity of 99.9999% or more), an oxygen-free copper, a phosphorus deoxidized copper and a tough pitch copper. Among these, it is advantageous to use the high-purity copper for the purpose of reducing a 0.2% proof stress.

The copper material may be formed in a plate having a flat rectangular cross-section using a die or a roller, and then may be shaped in copper wires of various widths by slitting.

The copper wire is annealed by a direct resistance heating or by an induction heating, with a heating temperature in a range of 650° C. to 1020° C. and a heating time in a range of 0.3 seconds to 5 seconds. In so far as the annealing conditions are in these ranges, the heating time may be increased when the heating temperature is low or the heating time may be shortened when the heating temperature is high.

To prevent oxidation of the copper, it is desirable to carry out the annealing under an inert gas atmosphere. The inert gas may be selected from nitrogen and rare gas.

It is practically undesirable if either of the heating temperature and the heating time of the annealing is outside the ranges described above, as the 0.2% proof stress of the interconnector becomes 80 MPa or more, and the 0.2% proof stress further increase and becomes greater than 100 MPa after the plating. Moreover, when either of the heating temperature and the heating time of the annealing is outside the ranges described above, an elongation value, an indicator of toughness, is lowered to 25% or less.

For example, when the heating temperature is 600° C., the 0.2% proof stress becomes 80 MPa or more. When the heating temperature is 1020° C. and the heating time exceeds 5 seconds, the elongation value lowers drastically.

When the heating time exceeds 5 seconds, the copper wire is heated along a longer range, in which case the copper wire is easily deformed due to deflection or the like. This is undesirable not only because it makes quality control difficult, but also from the viewpoint of reducing the heating time.

After the annealing, the surface of the copper wire is solder plated through a molten solder bath, whereby an interconnector for a solar cell is produced.

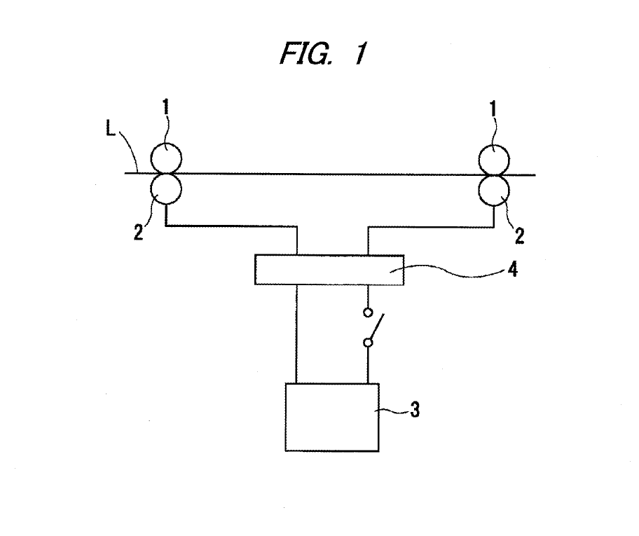

Examples of an apparatus for the annealing process are shown in FIGS. 1 to 3.

FIG. 1 is a diagram illustrating an apparatus configured to apply an electric current to a copper wire to perform an annealing process. This apparatus is an external transformer type resistance heating apparatus.

On each of an entrance side and an exit side of a feeding path of a copper wire L, an auxiliary roll 1 and a conductive roll 2 are opposed to each other with the copper wire L interposed therebetween. A low-frequency power source 3 and a transformer 4 are connected to the conductive rolls 2. The copper wire L is heated by a direct resistance heating using the conductive rolls 2.

The heating time is controlled by the distance from the entrance side to the exit side of the feeding path of the copper wire L and the feeding speed of the copper wire L. The heating temperature is controlled by one or both of the output current and the output voltage of the transformer 4.

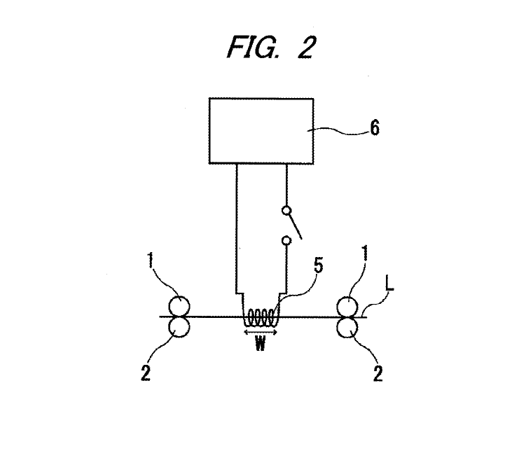

FIG. 2 is a diagram illustrating an annealing apparatus using an induction heating.

The copper wire L is fed through the inside of a heating coil 5, and is held between an auxiliary roll 1 and a conductive roll 2 on each of an entrance side and an exit side of the feeding path of the copper wire L. A high-frequency power source 6 is connected to the heating coil 5. By an electromagnetic induction, an eddy current is induced in the copper wire L inside the heating coil 5, whereby the copper wire L is heated.

The heating time is controlled by the width W of the heating coil 5 and the feed speed of the copper wire L. The heating temperature is controlled by one or both of the output current and the output voltage of the high-frequency power source 6.

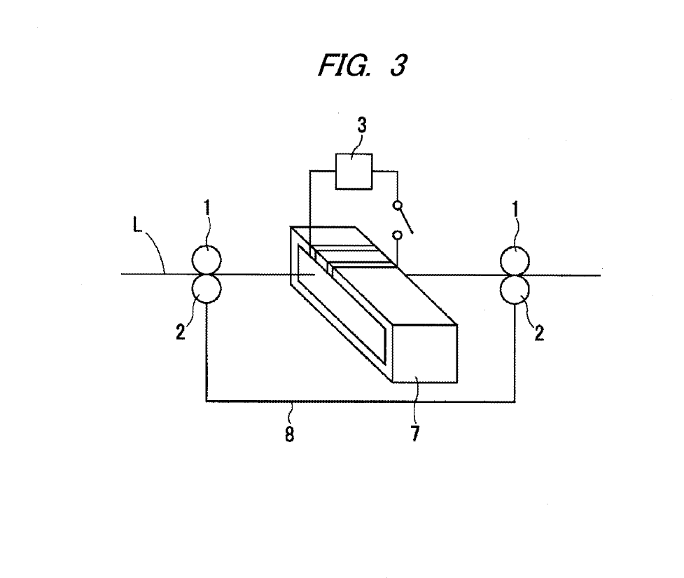

FIG. 3 is a diagram illustrating an annealing apparatus using a direct resistance heating. This apparatus is a ring transformer type resistance heating apparatus.

On each of an entrance side and an exit side of the feeding path of the copper wire L, an auxiliary roll 1 and a conductive roll 2 are opposed to each other with the copper wire L interposed therebetween. A ring transformer 7 connected to a lower-frequency power source 3 is disposed between the entrance side and the exit side of the feeding path of the copper wire L. The two conductive rolls 2 are short-circuited by being connected to each other via a conductive wire 8. Due to the voltage induced in the copper wire L, an electric current flows through the copper wire L via the conductive rolls 2 and the conductive wire 8. This type of direct resistance heating using a ring transformer is also called as an inductive coupled conduction heating.

The heating time is controlled by the distance from the entrance side to the exit side of the feeding path of the copper wire L and the feeding speed of the copper wire L. The heating temperature is controlled by one or both of the output current and the output voltage of the low-frequency power source 3.

While FIGS. 1 to 3 illustrates only one copper wire L, a plurality of copper wires may be annealed simultaneously.

### EXAMPLES

Using the external transformer type resistance heating apparatus, a copper wire with a sectional size of 0.2 mm thickness×2 mm width was annealed under the following conditions.

### Comparative Examples 1 to 3

Heating Temperature: 600° C.

Heating Time: 0.5 seconds, 3 seconds and 5 seconds, respectively

### Examples 1 to 3

Heating Temperature: 650° C.

Heating Time: 0.5 seconds, 3 seconds and 5 seconds, respectively

### Examples 4 to 6

Heating Temperature: 800° C.

Heating Time: 0.5 seconds, 3 seconds and 5 seconds, respectively

### Examples 7 to 9

Heating Temperature: 900° C.

Heating Time: 0.3 seconds, 3 seconds and 5 seconds, respectively

### Examples 10 to 12

Heating Temperature: 1000° C.

Heating Time: 0.3 seconds, 3 seconds and 5 seconds, respectively

### Examples 13 to 15

Heating Temperature: 1020° C.

Heating Times: 0.3 seconds, 3 seconds and 5 seconds, respectively

### Comparative Example 4

Heating Temperature: 1020° C.

Heating Time: 10 seconds

When the heating time of the annealing process was longer than 5 seconds, an oxygen-free copper was deflected and caused deformation. Thus, it was difficult to maintain the quality of the interconnector.

The 0.2% proof stress of the oxygen-free copper and the interconnector after the annealing was measured based on JIS-Z-2241. The elongation value of the interconnector was measured based on JIS-Z-2201. The measurement results are shown in Table 1.

TABLE 1

| | | | Proof Stress | Elongation |
|---|---|---|---|---|
| | Annealing | Annealing | of Copper | of Copper |
| | Temperature | Time | Material | Material |
| | (° C.) | (sec) | (MPa) | (%) |
| Com. Ex. 1 | 600 | 5 | 85 | 38 |
| Com. Ex. 2 | 600 | 3 | 90 | 37 |
| Com. Ex. 3 | 600 | 0.5 | 95 | 35 |
| Ex. 1 | 650 | 5 | 65 | 35 |
| Ex. 2 | 650 | 3 | 70 | 38 |
| Ex. 3 | 650 | 0.5 | 75 | 37 |
| Ex. 4 | 800 | 5 | 55 | 35 |
| Ex. 5 | 800 | 3 | 60 | 36 |
| Ex. 6 | 800 | 0.5 | 60 | 36 |
| Ex. 7 | 900 | 5 | 45 | 33 |
| Ex. 8 | 900 | 3 | 50 | 34 |
| Ex. 9 | 900 | 0.3 | 55 | 35 |
| Ex. 10 | 1000 | 5 | 35 | 30 |
| Ex. 11 | 1000 | 3 | 40 | 30 |
| Ex. 12 | 1000 | 0.3 | 42 | 32 |
| Ex. 13 | 1020 | 5 | 25 | 28 |
| Ex. 14 | 1020 | 3 | 26 | 30 |
| Ex. 15 | 1020 | 0.3 | 30 | 28 |
| Com. Ex. 4 | 1020 | 10 | 25 | 26 |

The 0.2% proof stress of the interconnector was greater than 80 MPa in Comparative Examples 1 to 3 in which the heating temperature was lower than 650° C. The 0.2% proof stress of the interconnector was smaller than 80 MPa in Examples 1 to 15. In Examples 1 to 15, the higher the heating temperature, there was a tendency that the 0.2% proof stress became smaller. Also, the longer the heating time, there was a tendency that the 0.2% proof stress became smaller.

Similarly to the interconnector, the 0.2% proof stress of the oxygen-free copper after the annealing exhibited a tendency that the 0.2% proof stress became lower, as the heating temperature is increased and as the heating time is made longer.

The elongation value was greater than 25% in all of Examples 1 to 15 and Comparative Examples 1 to 3.

From Examples 1 to 15, it was found that the heating time that required 30 seconds or more with the conventional indirect heating can be significantly shortened by the annealing with a direct resistance heating in a range of 650° C. to 1020° C., and that the 0.2% proof stress was not adversely affected when the heating time was in the range of 0.3 seconds to 5 seconds, whereby an excellent interconnector for a solar cell can be produced.

While the invention has been described with reference to certain embodiments thereof, the scope of the invention is not limited to the embodiments described above, and it will be understood by those skilled in the art that various changes and modifications may be made therein without departing from the scope of the invention as defined by the appended claims.

### INDUSTRIAL APPLICABILITY

One or more embodiments of the invention provide an annealing method which can reduce a 0.2% proof stress of a conductor with a shorter heating time.

This application is based on Japanese Patent Application No. 2011-215137 filed on Sep. 29, 2011, the entire content of which is incorporated herein by reference.

1. A method of annealing a copper wire for an interconnector, the method comprising heating a copper wire by a direct resistance heating or by an induction heating, wherein a heating temperature of the heating is in a range of 650° C. to 1020° C., and a heating time of the heating is in a range of 0.3 seconds to 5 seconds.

2. The method according to claim 1, wherein the heating is carried out under an inert gas atmosphere.

3. The method according to claim 1, wherein the copper wire has a flat rectangular sectional shape, and is made of a tough pitch copper, an oxygen-free copper, a phosphorus deoxidized copper or a high-purity copper.

4. The method according to claim 2, wherein the copper wire has a flat rectangular sectional shape, and is made of a tough pitch copper, an oxygen-free copper, a phosphorus deoxidized copper or a high-purity copper.
